(19) United States
(12) Patent Application Publication
(10) Pub. No.: US 2019/0346032 A1
(43) Pub. Date: Nov. 14, 2019

(54) DRIVING SHAFT LOCK-UP DEVICE, POWER DRIVING SYSTEM, AND VEHICLE

(71) Applicant: BYD COMPANY LIMITED, Shenzhen, Guangdong (CN)

(72) Inventors: Ming BEI, Shenzhen (CN); Heping LING, Shenzhen (CN); Zhen ZHAI, Shenzhen (CN); Changan HUANG, Shenzhen (CN); Yongmeng LUO, Shenzhen (CN)

(73) Assignee: BYD Company Limited, Shenzhen, Guangdong (CN)

(21) Appl. No.: 16/474,430

(22) PCT Filed: Dec. 15, 2017
(86) PCT No.: PCT/CN2017/116619

§ 371 Date: Jun. 27, 2019

(30) Foreign Application Priority Data
Dec. 27, 2016 (CN) 201611229306.X

(51) Int. Cl. F16H 48/34; B60K 17/02; B60K 17/16; B62D 11/04

(52) U.S. Cl. CPC F16H 48/34; B62D 11/04; B60K 17/16; B60K 17/02

(57) ABSTRACT

The present specification discloses a drive shaft locking device, a power-driven system, and a vehicle. The drive shaft locking device comprises a planetary gear mechanism a first drive shaft, a second drive shaft, and a power joint device. The power joint device comprises a first joint part and a second joint part. The first joint part moves along the axial direction relative to the first drive shaft. A joint part drive device comprises a drive needle and a drive part. The drive needle rotates around the central axis of the sun gear along with a gear ring and moves along the axial direction relative to the gear ring to drive the drive needle for joining the first joint part with the second joint part.

### CROSS-REFERENCE TO RELATED APPLICATIONS

This application claims priority to Chinese Patent Application Serial No. 201611229306.X, filed with the State Intellectual Property Office of P. R. China on Dec. 27, 2016. The entire content of the above-referenced application is incorporated herein by reference.

### FIELD

The present specification relates to the technical field of vehicles, and particularly relates to a drive shaft locking device for a vehicle, a power-driven system with the drive shaft locking device, and a vehicle with the power-driven system.

### BACKGROUND

In related technologies, a new energy vehicle may utilize a distributed drive mode. Wheels at two sides of the vehicle are respectively driven by two motors. The rotation speeds and torques of the wheels at left and right can be independently adjusted respectively by a controller, thereby canceling a differential mechanism. However, when the road is slippery, a left half shaft and a right half shaft still need to be locked to improve the mobility of the vehicle. If a conventional electric locking differential mechanism is applied to a new energy vehicle with a distributed-drive mode, the differential function of the differential mechanism may be wasted. Furthermore, the conventional electric locking differential mechanism has a complicated structure with more parts and occupies a larger space.

### SUMMARY

An objective of the present specification is to solve the technical problems in the related art. Therefore, the present specification provides a drive shaft locking device for a vehicle. The drive shaft locking device can lock two drive shafts together to improve the vehicle mobility under difficult drive conditions.

Some embodiments of the present specification further provide a power-driven system.

Some embodiments of the present specification further provide a vehicle.

The drive shaft locking device for the vehicle, provided by some embodiments of the present specification, may comprise a planetary gear mechanism, wherein the planetary gear mechanism comprises a sun gear, planetary gears, planetary carriers and a gear ring. A first drive shaft, a second drive shaft, and a power joint device. The power joint device comprises a first joint part and a second joint part. The planetary carriers are respectively connected with the first drive shaft and the first joint part so as to enable the planetary carriers, the first drive shaft and the first joint part to synchronously rotate. The first joint part moves along the axial direction relative to the first drive shaft, and the second drive shaft is respectively connected with the sun gear and the second joint part so as to enable the second drive shaft, the second joint part and the sun gear to synchronously rotate. A joint part drive device comprises a drive needle and a drive part. The drive needle is configured to rotate around the central axis of the sun gear along with the gear ring and move along the axial direction relative to the gear ring. Two ends of the drive needle are respectively matched with the drive part and the first joint part. The drive part is configured to drive the drive needle to drive the first joint part to move towards the second joint part along the axial direction, so that the first joint part is joined with the second joint part.

According to the drive shaft locking device provided by the present specification, when the first joint part is joined with the second joint part, the first drive shaft and the second drive shaft are mutually locked together, and the first drive shaft and the second drive shaft can synchronously rotate, such that the vehicle has improved mobility under difficult driving conditions to get out of trouble. Furthermore, by the joint part drive device and the power joint device, the locking of the first drive shaft and the second drive shaft can be implemented. Thus, the drive shaft locking device has the advantages of a simple structure, reliable functional implementation, few parts, a small size, and a low cost.

In addition, the drive shaft locking device provided by the present specification can also have the following distinguishing technical features.

In some embodiments of the present specification, two planetary carriers are respectively arranged at two sides of the sun gear.

In some examples of the present specification, the two planetary carriers include an axially fixed planetary carrier and an axially moving planetary carrier. The axially fixed planetary carrier is fixed with the first drive shaft, the axially moving planetary carrier is fixed with the first joint part and can move along the axial direction relative to the axially fixed planetary carrier.

In some embodiments of the present specification, the planetary gears are provided with planetary gear shafts. The planetary gear shafts are respectively connected with the axially fixed planetary carrier and the axially moving planetary carrier, and the planetary gear shafts and the axially moving planetary carrier are in slide connection.

In some embodiments of the present specification, the gear ring has a drive needle axial groove, and the drive needle is slidably arranged in the drive needle axial groove.

In some embodiments of the present specification, the drive shaft locking device comprises elastic devices. The elastic devices are elastically arranged between the first joint part and the second joint part so as to enable the first joint part to move away from the second joint part.

In some embodiments of the present specification, the drive part comprises a following part. The following part can rotate along with the drive needle or can be braked. The following part has a drive surface. When the following part is braked, the drive surface drives the drive needle to move along the axial direction by sliding the drive needle on the drive surface, so that the first joint part is joined with the second joint part.

In some embodiments of the present specification, the drive part comprises a braking part, wherein the braking part is configured for braking the following part.

In some embodiments of the present specification, the braking part is configured to brake the following part by an electromagnetic force.

In some embodiments of the present specification, the drive part is an electromagnetic brake, the following part constitutes a braking component of the electromagnetic brake, and the braking part constitutes a braking frame of the electromagnetic brake.

In some embodiments of the present specification, the following part hollowly sleeves the first drive shaft.

In some embodiments of the present specification, the drive surface includes an inclined surface or a curved surface.

In some embodiments of the present specification, the drive surface comprises a first section and a second section. The first section is connected with the second section. The connection part of the first section and the second section is the lowest point, and the other ends of the first section and the second section opposite from the connection part are the highest points.

In some embodiments of the present specification, the following part comprises a following part body and an annular following part flange arranged on the following part body. The end surface of the following part flange facing the drive needle is provided with the drive surface.

In some embodiments of the present specification, the drive surface has a drive surface limiting groove, and one end of the drive needle is positioned in the drive surface limiting groove.

In some embodiments of the present specification, the first joint part hollowly sleeves the second drive shaft.

In some embodiments of the present specification, the first joint part has a plurality of first joint teeth distributed along the circumferential direction, and the second joint part has a plurality of second joint teeth distributed along the circumferential direction.

In some embodiments of the present specification, the drive needle fits with the first joint part.

The power-driven system provided by the present specification comprises the drive shaft locking device for the vehicle, a first motor generator, and a second motor generator. The first motor generator is in transmission with the first drive shaft and outputs power to one of a pair of wheels, and the second motor generator is in transmission with the second drive shaft and outputs power to the other one of the pair of wheels.

The benefits of the power-driven system are the same as the benefits of the drive shaft locking device, so that the descriptions are not repeated herein.

The vehicle provided by the present specification comprises the power-driven system.

The benefits of the vehicle are the same as the benefits of the power-driven system, so that the descriptions are not repeated herein.

### BRIEF DESCRIPTION OF THE DRAWINGS

FIG. 1 is a schematic diagram of a drive shaft locking device according to an embodiment of the present specification;

FIG. 2 is an exploded diagram of a drive shaft locking device according to an embodiment of the present specification;

FIG. 3 is a structural diagram of a following part according to an embodiment of the present specification;

FIG. 4 is a schematic diagram of a power-driven system according to an embodiment of the present specification; and

FIG. 5 is a schematic diagram of a power-driven system according to an embodiment of the present specification.

### REFERENCE NUMERALS OF THE ACCOMPANYING DRAWING

Power-driven system 1000;

Drive shaft locking device 100;

Planetary gear mechanism 10; Sun gear 11; Planetary gear 12; Planetary carrier 13; Axially fixed planetary carrier 131; Axially moving planetary carrier 132;

Gear ring 14; Drive needle axial groove 141;

First drive shaft 20; Second drive shaft 30;

Power joint device 40; First joint part 41; First joint tooth 411;

Second joint part 42; Second joint tooth 422;

Joint part drive device 50; Drive needle 51; Drive part 52; Following part 521; Following part body 521a; Following part flange 521b;

Braking part 522;

Drive surface 523; First section 523a; Second section 523b; Drive surface limiting groove 523c;

Elastic device 70;

First motor generator D1; Second motor generator D2; Third motor generator D3; Fourth motor generator D4;

Left front wheel Z1; Left rear wheel Z2; Right front wheel Y1; Right rear wheel Y2.

### DETAILED DESCRIPTION

The embodiments of the present specification are described in detail below are illustrated in the accompanying drawings. The following embodiments described with reference to the accompanying drawings are exemplary, are intended to describe the present specification, and shall not be construed as a limitation to the present specification.

A drive shaft locking device 100 according to an embodiment of the present specification is described in detail below with reference to the accompanying drawings. The drive shaft locking device 100 can be applied to a vehicle, particularly applicable to a new energy vehicle utilizing distributed drive. The drive shaft locking device 100 can be used for locking two drive shafts to enable left and right wheels to synchronously rotate, thereby greatly improving the mobility of the vehicle under difficult driving conditions (i.e., a slippery road) to get out of trouble. The vehicle can be, but is not limited to, an electric vehicle.

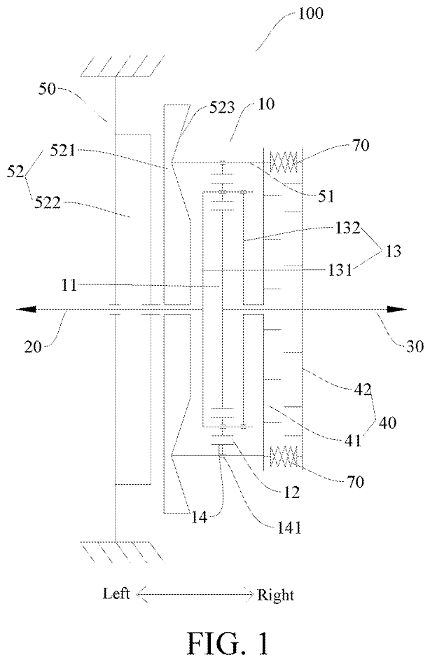

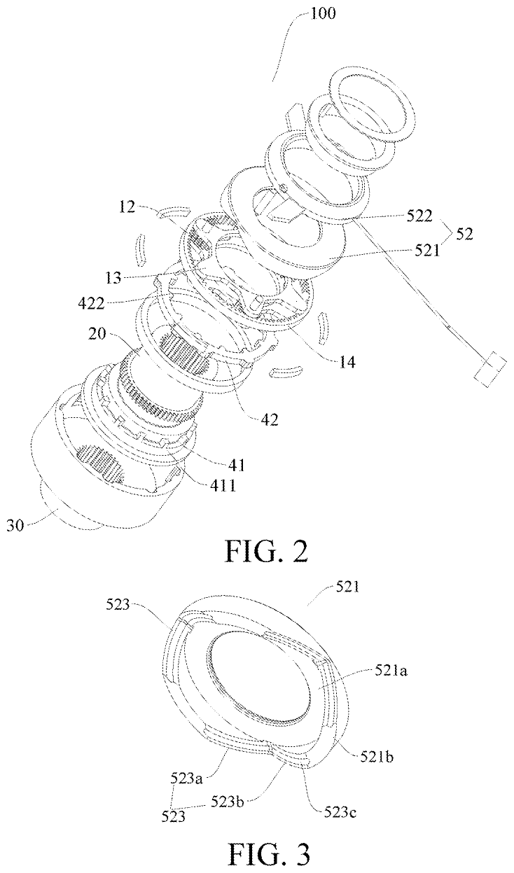

As shown in FIG. 1 and FIG. 2, the drive shaft locking device 100 according to an embodiment of the present specification can comprise a planetary gear mechanism 10, a first drive shaft 20, a second drive shaft 30, a power joint device 40, and a joint part drive device 50.

The planetary gear mechanism 10 comprises a sun gear 11, planetary gears 12, planetary carriers 13, and a gear ring 14. The planetary gears 12 can be rotationally mounted on the planetary carriers 13, and the planetary gears 12 are meshed between the sun gear 11 and the gear ring 14 to transmit power between the sun gear 11 and the gear ring 14. A plurality of planetary gears 12 (e.g., three planetary gears) can be uniformly distributed with respect to the central axis of the sun gear 11. Planetary gear shafts can be mounted on the planetary carriers 13, and the planetary gears 12 can be mounted on the planetary gear shafts.

The first drive shaft 20 and the second drive shaft 30 are two independent shafts. For example, the first drive shaft 20 can be, but not limited to, in transmission with a left wheel, and the second drive shaft 30 can be, but not limited to, in transmission with a right wheel. The axis of the first drive shaft 20 and the axis of the second drive shaft 30 can be collinear. For another example, the first drive shaft 20 can be a right half shaft, and the second drive shaft 30 can be a left half shaft.

The power joint device 40 can comprise a first joint part 41 and a second joint part 42. As shown in FIG. 1, the planetary carriers 13 are respectively connected with the first drive shaft 20 and the first joint part 41 to enable the planetary carriers 13, the first drive shaft 20, and the first joint part 41 to synchronously rotate, and the first joint part 41 to move along the axial direction relative to the first drive shaft.

The second drive shaft 30 can be respectively connected with the sun gear 11 and the second joint part 42 to enable the second drive shaft 30, the second joint part 42, and the sun gear 11 to synchronously rotate.

The joint part drive device 50 can comprise a drive needle 51 and a drive part 52. The drive needle 51 is configured to rotate with the gear ring 14 around the central axis of the sun gear 11, and to move along the axial direction relative to the gear ring 14.

Two ends of the drive needle 51 are respectively matched with the drive part 52 and the first joint part 41. The drive part 52 is configured to drive the drive needle 51 to move along the axial direction to drive the first joint part 41 to move towards the second joint part 42 along the axial direction (from left to right as shown in FIG. 1), so that the first joint part 41 can be joined with the second joint part 42.

In other words, the gear ring 14 can drive the drive needle 51 to synchronously rotate therewith. For example, as shown in FIG. 1, the gear ring 14 is provided with a drive needle axial groove 141, and the drive needle 51 can be slidably arranged in the drive needle axial groove 141. Furthermore, the drive part 52 can drive the drive needle 51 to move from left to right. One end of the drive needle 51 is matched with the first joint part 41 to synchronously drive the first joint part 41 to move from left to right to join the first joint part 41 with the second joint part 42. When the first joint part 41 is joined with the second joint part 42, the first drive shaft 20 and the second drive shaft 30 are mutually locked and synchronously rotate. Thus, the power at the sliding side of the vehicle can be output through the other side to improve the mobility of the vehicle under difficult driving conditions.

A conventional electric locking differential mechanism is formed by adding an electric actuation locking mechanism on a common open differential mechanism, so that the differential mechanism has a locking function, and the locking can be achieved by electrical control of the differential mechanism. The electric locking differential mechanism is usually applied to a fuel vehicle of centralized drive type, wherein the power is distributed to a left half shaft and a right half shaft through a main reducing gear and the differential mechanism. The speed difference between a left wheel and a right wheel is adjusted by the differential mechanism. However, the electric locking differential mechanism cannot be directly applied to an electric vehicle, since the electric vehicle does not have an engine, and the electric locking differential mechanism is too large.

Therefore, the drive shaft locking device 100 provided by the embodiments of the present specification is significantly different from the conventional electric locking differential mechanism both in structure and implementation. Furthermore, the locking of the first drive shaft 20 and the second drive shaft 30 can be implemented by the joint part drive device 50 and the power joint device 40. The drive shaft locking device 100 has the advantages of a simple structure, reliable function implementation, few parts, a small size, and a low cost. The power joint device 40 is reliably and stably joined to improve the working reliability of the drive shaft locking device 100.

As shown in FIG. 1, the planetary gear mechanism 10, the power joint device 40, the first drive shaft 20 and the second drive shaft 30 are coaxially arranged. Therefore, the drive shaft locking device 100 can have a small radial size, a small overall size, and occupy less space.

According to an embodiment of the present specification, as shown in FIG. 1, two planetary carriers 13 can be respectively arranged at two sides of the sun gear l lfor a better structural reliability of the planetary gear mechanism 10. The planetary carriers 13 can be respectively connected with the first drive shaft 20 and the first joint part 41 to improve the structural reliability of the drive shaft locking device 100. The drive needle 51 can be mounted more coaxially to ensure that the drive needle 51 to deviate less when moving along the axial direction.

Further, as shown in FIG. 1, the two planetary carriers 13 can include an axially fixed planetary carrier 131 and an axially moving planetary carrier 132. The axially fixed planetary carrier 131 is fixed with the first drive shaft 20. The axially moving planetary carrier 132 can be fixed with the first joint part 41 and move along the axial direction relative to the axially fixed planetary carrier 131. In other words, the axially fixed planetary carrier 131 can be used for being fixed with the first drive shaft 20, and the axially moving planetary carrier 132 can be used for being fixed with the first joint part 41.By the axial movement of the axially moving planetary carrier 132 relative to the first drive shaft 20 and the axially fixed planetary carrier 131, the first joint part 41 can move towards the second joint part 42 along the axial direction, and the first drive shaft 20, the axially fixed planetary carrier 131, the axially moving planetary carrier 132, and the first joint part 41 can synchronously rotate.

Specifically, the planetary gears 12 can be provided with planetary gear shafts respectively connected with the axially fixed planetary carrier 131 and the axially moving planetary carrier 132. The planetary gear shafts are in slide connection with the axially moving planetary carrier 132 to facilitate the axial movement of the axially moving planetary carrier 132 and to ensure the working reliability of the drive shaft locking device 100.

In some embodiments of the present invention, as shown in FIG. 1, the drive shaft locking device 100 can further comprise elastic devices 70. The elastic devices 70 are elastically arranged between the first joint part 41 and the second joint part 42 for the first joint part 41 to move away from the second joint part 42. Therefore, the elastic devices 70 can supply a counter force to the first joint part 41for the first joint part 41 to move away from the second joint part 42 along the axial direction until the first joint part 41 is completely separated from the second joint part 42. At this time, the drive shaft locking device 100 releases the locking of the two drive shafts.

As shown in FIG. 1, the drive part 52 can comprise a following part 521. The following part 521 can rotate along with the drive needle 51 or can be braked. The following part 521 is provided with a drive surface 523. When the following part 521 is braked, the drive needle 51 may slide on the drive surface 523 to change the contact matching position of the drive needle 51 and the drive surface 523. The drive surface 523 drives the drive needle 51 to move along the axial direction to join the first joint part 41 with the second joint part 42. It can be understood that before the following part 521 is braked, the following part 521 and the drive needle 51 synchronously rotate. After the following part 521 is braked, the rotation speed of the following part 521 is reduced and is different than the rotation speed of the drive needle 51, so that the drive needle 51 can slide on the drive surface 523 of the following part 521. The drive needle 51 can move along the axial direction relative to the planetary carriers 13 to drive the first joint part 41 to gradually approach the second joint part 42 until the first joint part 41 is joined with the second joint part 42.

Further, as shown in FIG. 1, the drive part 52 can further comprise a braking part 522, wherein the braking part 522 is configured for braking the following part 521. In other words, the braking part 522 can brake the following part 521. When the first joint part 41 and the second joint part 42 need to be joined, the braking part 522 can brake the following part 521.

In some embodiments of the present specification, the braking part 522 can be configured to brake the following part 521 by an electromagnetic force. The electromagnetic force may be precisely and reliably controlled to improve the working reliability of the drive shaft locking device 100, and to prolong the service life of the drive shaft locking device 100. For example, the drive part 52 can be an electromagnetic brake. The electromagnetic brake may include a braking component and a braking frame, wherein the braking component includes the following part 521, and the braking frame includes the braking part 522. By using the control mode of the electromagnetic brake and the planetary gear mechanism, the control system of the drive shaft locking device 100 can be simplified, and the system reliability can be further improved.

In some embodiments of the present invention, as shown in FIG. 1, the following part 521 can hollowly sleeve the first drive shaft 20. Therefore, the matching between the following part 521 and the drive needle 51 can be further facilitated, the axial length of the drive shaft locking device 100 can be reduced, and the size of the drive shaft locking device 100 can be also reduced.

According to an embodiment of the present specification, as shown in FIG. 3, the drive surface 523 can be an inclined surface or a curved surface configured to facilitate the drive needle 51 to slide on the drive surface 523 and to move along the axial direction.

Further, the drive surface 523 can comprise a first section 523a and a second section 523b, wherein the first section 523a is connected with the second section 523b. The connection part of the first section 523a and the second section 523b is the lowest point, and the other ends of the first section 523a and the second section 523b opposite from the connection part are the highest points. Therefore, when one end of the drive needle 51 is positioned at the lowest point, the first joint part 41 and the second joint part 42 are separated. When one end of the drive needle 51 is positioned at a highest point or adjacent to the highest point, the first joint part 41 and the second joint part 42 are joined. By reasonably arranging the drive surface 523, the drive needle 51 may slide between the lowest point and the highest points to join the first joint part 41 with the second joint part 42 for improving the working reliability of the drive shaft locking device 100.

In some embodiments of the present invention, each of the first section 523a and the second section 523b can be of an arc shape to facilitate one end of the drive needle 51 to slide on the drive surface 523 for reducing the moving resistance of the drive needle 51.

In some embodiments of the present invention, each of the first section 523a and the second section 523b has the same center angle. Thus, the first section 523a and the second section 523b are basically identical, thereby further facilitating the sliding of the drive needle 51 on the drive surface 523.

In some embodiments of the present invention, multiple sections of drive surfaces 523 can be provided and distributed at intervals along the circumferential direction. Therefore, the number of the drive needles 51 can be corresponding to the number of the drive surfaces 523. The number of the drive needles 51 can be increased. A plurality of drive needles 51 can be reliably matched with the first joint part 41. Thus, the second joint part 42 can reliably move along the axial direction, and the operation of the drive shaft locking device 100 is more reliable.

Multiple sections of drive surfaces 523 can be connected by a connection plane, and the connection plane is flush with the highest points. Thus, the structural reliability of the drive surface 523 of the following part 521 can be improved to further improve the structural reliability of the drive shaft locking device 100.

According to an embodiment of the present specification, as shown in FIG. 3, the following part 521 can comprise a following part body 521a and an annular following part flange 521b arranged on the following part body 521a, wherein the drive surface 523 is arranged on the end surface of the following part flange 52 lb facing the drive needle 51. The following part body 521a can effectively enhance the structural reliability of the following part 521. The drive surface 523 can be arranged on the end surface of the following part flange 521b to reduce the design difficulty of the drive surface 523 and improve the structural reliability of the drive surface 523.

Further, as shown in FIG. 3, the drive surface 523 can be provided with a drive surface limiting groove 523c, and one end of the drive needle 51 is positioned in the drive surface limiting groove 523c. By forming the drive surface limiting groove 523c, one end of the drive needle 51 can fit in the drive surface limiting groove 523c to prevent one end of the drive needle 51 from being separated from the drive surface 523 to improve the reliability and stability of the drive needle 51 moving on the drive surface 523.

As shown in FIG. 1, the first joint part 41 can hollowly sleeve the second drive shaft 30 to reduce the axial size of the drive shaft locking device 100 and the volume of the drive shaft locking device 100. In addition, the arrangement reliability of the first joint part 41 can also be improved.

Specifically, as shown in FIG. 2, the first joint part 41 is provided with a plurality of first joint teeth 411 distributed along the circumferential direction, and the second joint part 42 is provided with a plurality of second joint teeth 422 distributed along the circumferential direction. It can be understood that when the first joint teeth 411 are matched with the second joint teeth 422, the first joint part 41 is joined with the second joint part 42. By the arrangement of the plurality of first joint teeth 411 and the plurality of second joint teeth 422, the matching reliability of the first joint part 41 and the second joint part 42 can be improved.

Further, the drive needle 51 is fit with the first joint part 41 to ensure the matching reliability between the drive needle 51 and the first joint part 41 and to improve the working reliability of the drive shaft locking device 100.

A power-driven system 1000 according to an embodiment of the present specification is described in detail below.

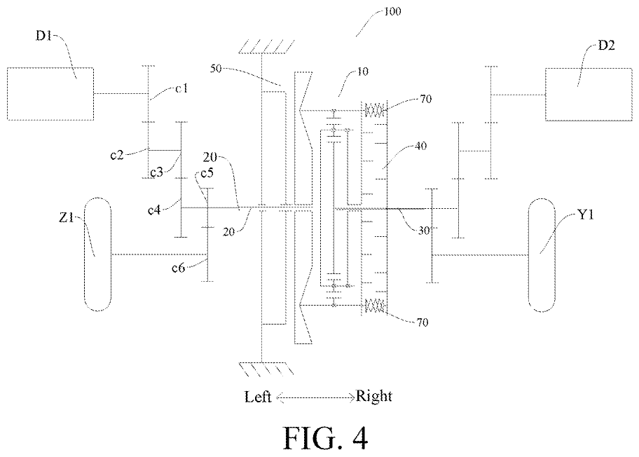

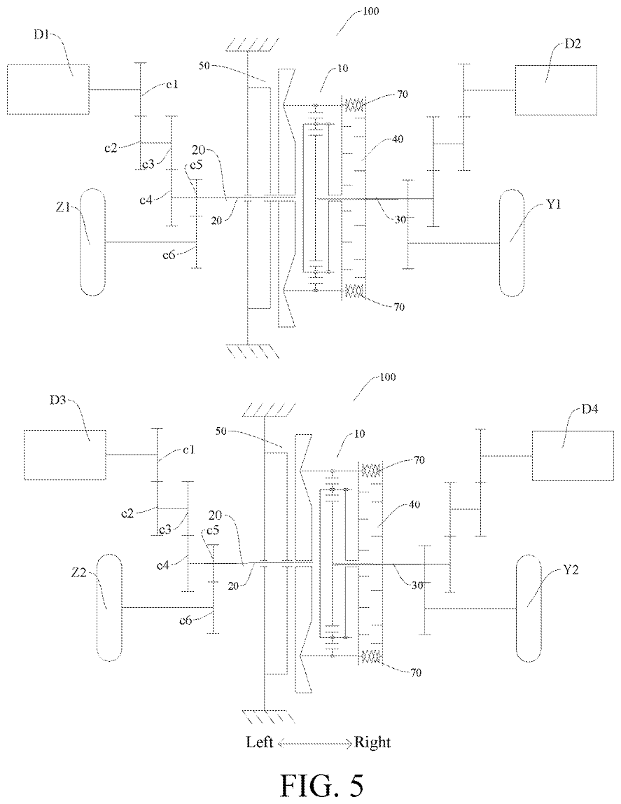

As shown in FIG. 4 and FIG. 5, the power-driven system 1000 can comprise the drive shaft locking device 100 for a vehicle according to the above embodiments, a first motor generator D1, and a second motor generator D2. The first motor generator D1 is in transmission with the first drive shaft 20 and outputs power to one of a pair of wheels. The second motor generator D2 is in transmission with the second drive shaft 30 and outputs power to the other one of the pair of wheels. When the drive shaft locking device 100 locks the first drive shaft 20 and the second drive shaft 30 together, the two wheels can synchronously rotate. When the drive shaft locking device 100 does not lock the first drive shaft 20 and the second drive shaft 30 together, the first motor generator D1 and the second motor generator D2 can work separately so as to drive the corresponding wheel to rotate at a suitable rotation speed.

As shown in FIG. 4, in the power-driven system 1000, the drive shaft locking device 100 according to the above embodiments can be applied to a group of wheels. A first gear cl, a second gear c2, a third gear c3, a fourth gear c4, a fifth gear c5, and a sixth gear c6 are arranged between the first motor generator D1 and a left front wheel Z1. The first gear c1 is fixed on the motor shaft of the first motor generator D1, and the second gear c2 is meshed with the first gear cl. The second gear c2 and the third gear c3 are coaxially fixed, the third gear c3 is meshed with the fourth gear c4, the fourth gear c4 is fixed on the first drive shaft 20, and the fifth gear c5 is fixed on the first drive shaft 20. The half shaft of the left front wheel Z1 is connected with the sixth gear c6, and the fifth gear c5 is meshed with the sixth gear c6. Thus, the power of the first motor generator D1 can be transmitted to the left front wheel Z1 by the three groups of meshed gears. Of course, the first drive shaft 20 can also achieve some corresponding functions in transmission processes. The transmissions between the first gear c1 and the second gear c2 as well as between the third gear c3 and the fourth gear c4 can reduce the speed and increase the torque.

Of course, the present specification is not limited thereto. As shown in FIG. 5, in the power-driven system 1000, the drive shaft locking device 100 according to the above embodiments can be applied to two groups of wheels. For example, two drive shaft locking devices 100 can be provided. A first drive shaft locking device 100 is matched in a left front wheel Z1 and a right front wheel Y1. The first motor generator D1 is in transmission with the first drive shaft 20 of the first drive shaft locking device 100, and the second motor generator D2 is in transmission with the second drive shaft 30 of the first drive shaft locking device 100.

The second drive shaft locking device 100 is matched in a left rear wheel Z2 and a right rear wheel Y2. A third motor generator D3 is in transmission with the first drive shaft 20 of the second drive shaft locking device 100, and a fourth motor generator D4 is in transmission with the second drive shaft 30 of the second drive shaft locking device 100.

The working processes and principles of the drive shaft locking device 100 according to the embodiments of the present specification are described in detail below with reference to the embodiments shown in FIG. 1 in conjunction with FIG. 4.

When a vehicle runs normally along a straight line, the first motor generator D1 and the second motor generator D2 work separately. A controller of the vehicle can control the first motor generator D1 and the second motor generator D2 to work in the same direction and at the ame speed, so that the left front wheel Z1 and the right front wheel Y1 can rotate at the same speed and in the same direction.

When the vehicle turns normally, the controller can control the first motor generator D1 and the second motor generator D2 to work in the same direction but at different rotation speeds. For example, when the vehicle needs to turn left, the rotation speed of the first motor generator D1, which is in transition with the left front wheel Z1, can be less than the rotation speed of the second motor generator D2, which is in transition with the right front wheel Y1. The rotation speed of the right front wheel Y1 is greater than the rotation speed of the left front wheel Z1, so that the vehicle can turn left.

In the process that the vehicle runs normally along a straight line or the vehicle turns normally, pressed by the elastic devices 70, one end of the drive needle 51 in the drive shaft locking device 100 is positioned at the lowest point of the drive surface 523 of the following part 521. At this time, the drive needle 51 and the following part 521 can synchronously rotate.

When the vehicle slides, a driver may power on the electromagnetic brake to work, and the braking frame brakes the braking component to control the rotation speed of the braking component. The rotation speed difference may occur between the drive needle 51 and the braking component, and the drive needle 51 slides on the drive surface 523 of the braking component. The drive needle 51 can slide from the lowest point of the drive surface 523 to the highest point or the position adjacent to the highest points. The drive needle 51 moves towards one side of the first joint part 41 along the axial direction, and drives the first joint part 41 to gradually approach the second joint part 42 until the first joint part 41 is joined with the second joint part 42. At this time, the first drive shaft 20 and the second drive shaft 30 synchronously rotate, thereby improving the capability of the vehicle to get out of a sliding situation.

After the vehicle gets out of the sliding situation, the driver can power off the electromagnetic brake by pressing the electromagnetic brake again. The elastic devices move away from the second joint part 42 along the axial direction. In his process, the drive needle 51 moves with the first joint part 41 along the axial direction. One end of the drive needle 51 matched with the drive surface 523 can slide to the lowest point from the highest points or the position adjacent to the highest points. At this time, the second joint part 42 and the first joint part 41 are completely separated, and the vehicle can continue to run normally along a straight line or to turn normally.

The vehicle according to the embodiments of the present specification comprises the power-driven system 1000 according to the above embodiments.

In the description of the specification, the description made with reference to terms such as “one embodiment”, “some embodiments”, “example”, “specific example”, or “some examples” means that a specific characteristic, structure, material or feature described with reference to the embodiments or examples is included in at least one embodiment or example of the present specification. In this specification, schematic descriptions of the foregoing terms do not need to refer to a same embodiment or example. In addition, the described specific features, structures, materials, or characteristics may be combined in a proper manner in any one or more of the embodiments or examples. In addition, a person skilled in the art may integrate or combine different embodiments or examples and characteristics of different embodiments or examples described in the specification, as long as they do not conflict with each other.

Although the above illustrations and descriptions refer to some embodiments of the present specification are shown and described above, it can be understood that, those embodiments are merely exemplary, and cannot be construed as a limitation to the present specification. Within the scope of the present specification, a person of ordinary skill in the art may make changes, modifications, replacements, and variations to the foregoing embodiments, which are also protected under the scope of the present specification.

1. A drive shaft locking device, comprising:
a planetary gear mechanism comprising a sun gear, planetary gears, planetary carriers, and a gear ring;
a first drive shaft, a second drive shaft, and a power joint device, wherein the power joint device comprises a first joint part and a second joint part, the planetary carriers are respectively connected with the first drive shaft and the first joint part to enable the planetary carriers, the first drive shaft, and the first joint part to synchronously rotate, the first joint part moves along the axial direction relative to the first drive shaft, and the second drive shaft is respectively connected with the sun gear and the second joint part to enable the second drive shaft, the second joint part, and the sun gear to synchronously rotate; and
a joint part drive device, wherein the joint part drive device comprises a drive needle and a drive part, wherein the drive needle is configured to rotate around the central axis of the sun gear along with the gear ring and move along the axial direction relative to the gear ring, two ends of the drive needle are respectively matched with the drive part and the first joint part, and the drive part is configured to drive the drive needle to drive the first joint part to move towards the second joint part along the axial direction to join the first joint part with the second joint part.

2. The drive shaft locking device according to claim 1, wherein the planetary carriers include two planetary carriers respectively arranged at two sides of the sun gear.

3. The drive shaft locking device according to claim 2, wherein the two planetary carriers include an axially fixed planetary carrier and an axially moving planetary carrier, the axially fixed planetary carrier is fixed with the first drive shaft, the axially moving planetary carrier is fixed with the first joint part and moves along the axial direction relative to the axially fixed planetary carrier.

4. The drive shaft locking device according to claim 3, wherein the planetary gears have planetary gear shafts, the planetary gear shafts are respectively connected with the axially fixed planetary carrier and the axially moving planetary carrier, and the planetary gear shafts and the axially moving planetary carrier are in slide connection.

5. The drive shaft locking device according to claim 1, wherein the gear ring has a drive needle axial groove, and the drive needle is slidably arranged in the drive needle axial groove.

6. The drive shaft locking device according to claim 1, further comprising: elastic devices, wherein the elastic devices are elastically arranged between the first joint part and the second joint part so as to enable the first joint part to move away from the second joint part.

7. The drive shaft locking device according to claim 1, wherein the drive part comprises:
a following part, wherein the following part rotates along with the drive needle, the following part has a drive surface, and when the following part is braked, the drive surface drives the drive needle to move along the axial direction by sliding the drive needle on the drive surface to join the first joint part with the second joint part.

8. The drive shaft locking device according to claim 7, wherein the drive part comprises:
a braking part configured to brake the following part.

9. The drive shaft locking device according to claim 8, wherein the braking part is configured to brake the following part by an electromagnetic force.

10. The drive shaft locking device according to claim 9, wherein the drive part includes an electromagnetic brake comprising a braking component and a braking frame, the braking component includes the following part, and the braking frame includes the braking part.

11. The drive shaft locking device according to claim 1, wherein the following part hollowly sleeves the first drive shaft.

12. The drive shaft locking device according to claim 1, wherein the drive surface includes an inclined surface or a curved surface.

13. The drive shaft locking device according to claim 1, wherein the drive surface comprises a first section and a second section, the first section is connected with the second section, a connection part of the first section and the second section is the lowest point, and other ends of the first section and the second section opposite to the connection part are the highest points.

14. The drive shaft locking device according to claim 13, wherein the following part comprises: a following part body and an annular following part flange arranged on the following part body, and the drive surface is disposed on an end surface of the following part flange facing the drive needle.

15. The drive shaft locking device according to claim 7, wherein the drive surface has a drive surface limiting groove, and one end of the drive needle is positioned in the drive surface limiting groove.

16. The drive shaft locking device according to claim 1, wherein the first joint part hollowly sleeves the second drive shaft.

17. The drive shaft locking device according to claim 1, wherein the first joint part has a plurality of first joint teeth distributed along the circumferential direction, and the second joint part has a plurality of second joint teeth distributed along the circumferential direction.

18. The drive shaft locking device according to claim 1, wherein the drive needle is fit with the first joint part.

19. A power-driven system, comprising:
the drive shaft locking device according to claim 1;
a first motor generator, wherein the first motor generator is in transmission with a first drive shaft and outputs power to one of a pair of wheels; and
a second motor generator, wherein the second motor generator is in transmission with a second drive shaft and outputs power to the other one of the pair of wheels.

20. A vehicle, comprising the power-driven system according to claim 19.
